(19) United States
(12) Patent Application Publication
(10) Pub. No.: US 2024/0298219 A1
(43) Pub. Date: Sep. 5, 2024

(54) BEAM REPORTING FOR INTER-CELL BEAM MANAGEMENT

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/578,577

(22) PCT Filed: Sep. 29, 2021
(86) PCT No.: PCT/CN2021/121677

§ 371 Date: Jan. 11, 2024

(51) Int. Cl. H04W 36/00; H04B 7/06

(52) U.S. Cl. CPC H04W 36/0058; H04B 7/06968

(57) ABSTRACT

Various aspects of the present disclosure generally relate to wireless communication. In some aspects, a user equipment (UE) may detect an event associated with beam reporting for inter-cell beam management. The UE may transmit a beam report based at least in part on detecting the event. Numerous other aspects are described.

### FIELD OF THE DISCLOSURE

Aspects of the present disclosure generally relate to wireless communication and to techniques and apparatuses for beam reporting for inter-cell beam management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include detecting an event associated with beam reporting for inter-cell beam management. The method may include transmitting a beam report based at least in part on detecting the event.

Some aspects described herein relate to a method of wireless communication performed by a base station. The method may include transmitting, to a UE, an indication of a configuration for transmitting a beam report based at least in part on detection of an event associated with beam reporting for inter-cell beam management. The method may include receiving the beam report based at least in part on detection of the event.

Some aspects described herein relate to a UE for wireless communication. The user equipment may include a memory and one or more processors coupled to the memory. The one or more processors may be configured to detect an event associated with beam reporting for inter-cell beam management. The one or more processors may be configured to transmit a beam report based at least in part on detecting the event.

Some aspects described herein relate to a base station for wireless communication. The base station may include a memory and one or more processors coupled to the memory. The one or more processors may be configured to transmit, to a UE, an indication of a configuration for transmitting a beam report based at least in part on detection of an event associated with beam reporting for inter-cell beam management. The one or more processors may be configured to receive the beam report based at least in part on detection of the event.

Some aspects described herein relate to a non-transitory computer-readable medium that stores a set of instructions for wireless communication by a UE. The set of instructions, when executed by one or more processors of the UE, may cause the UE to detect an event associated with beam reporting for inter-cell beam management. The set of instructions, when executed by one or more processors of the UE, may cause the UE to transmit a beam report based at least in part on detecting the event.

Some aspects described herein relate to a non-transitory computer-readable medium that stores a set of instructions for wireless communication by a base station. The set of instructions, when executed by one or more processors of the base station, may cause the base station to transmit, to a UE, an indication of a configuration for transmitting a beam report based at least in part on detection of an event associated with beam reporting for inter-cell beam management. The set of instructions, when executed by one or more processors of the base station, may cause the base station to receive the beam report based at least in part on detection of the event.

Some aspects described herein relate to an apparatus for wireless communication. The apparatus may include means for detecting an event associated with beam reporting for inter-cell beam management. The apparatus may include means for transmitting a beam report based at least in part on detecting the event.

Some aspects described herein relate to an apparatus for wireless communication. The apparatus may include means for transmitting, to a UE, an indication of a configuration for transmitting a beam report based at least in part on detection of an event associated with beam reporting for inter-cell beam management. The apparatus may include means for receiving the beam report based at least in part on detection of the event.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of receiving reference signals from non-serving cells, in accordance with the present disclosure.

FIG. 4 is a diagram illustrating an example associated with beam reporting for inter-cell beam management, in accordance with the present disclosure.

FIGS. 5 and 6 are diagrams illustrating example processes associated with beam reporting for inter-cell beam management, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

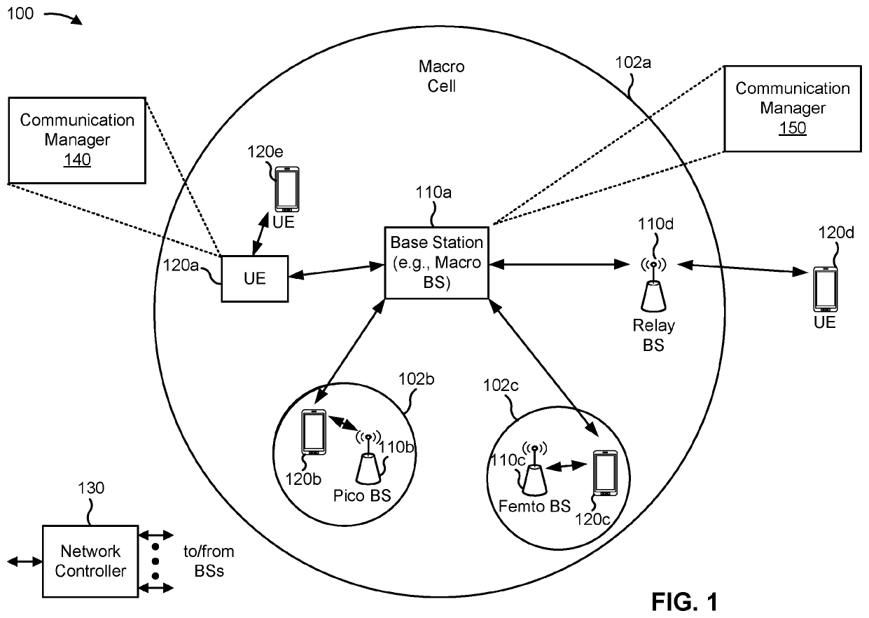

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may detect an event associated with beam reporting for inter-cell beam management, and transmit a beam report based at least in part on detecting the event. Additionally, or alternatively, the communication manager 140 may perform one or more other operations described herein.

In some aspects, the base station 110 may include a communication manager 150. As described in more detail elsewhere herein, the communication manager 150 may transmit, to a UE, an indication of a configuration for transmitting a beam report based at least in part on detection of an event associated with beam reporting for inter-cell beam management, and receive the beam report based at least in part on detection of the event. Additionally, or alternatively, the communication manager 150 may perform one or more other operations described herein.

As indicated above, FIG. 1 is provided as an example. Other examples may differ from what is described with regard to FIG. 1.

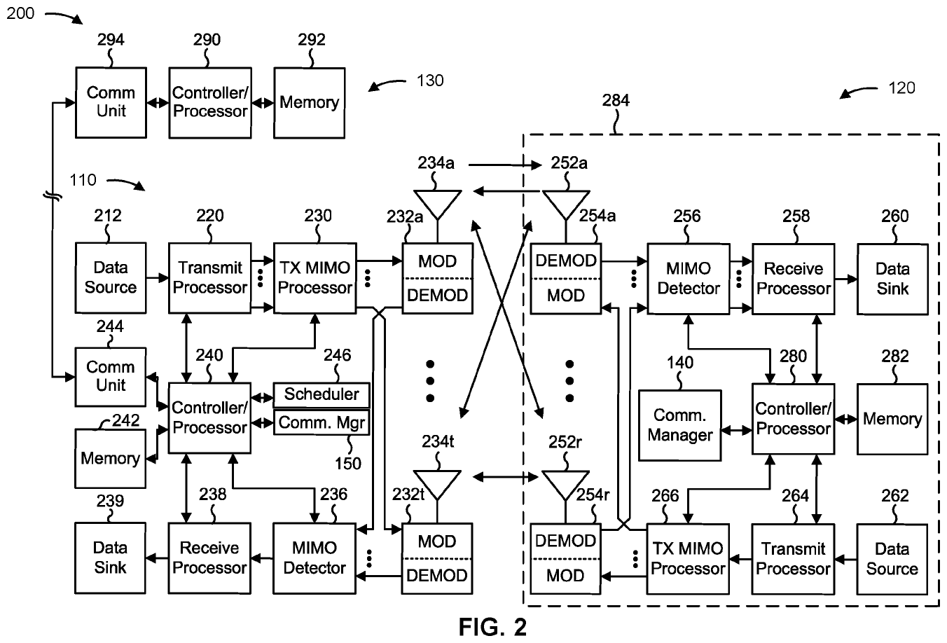

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

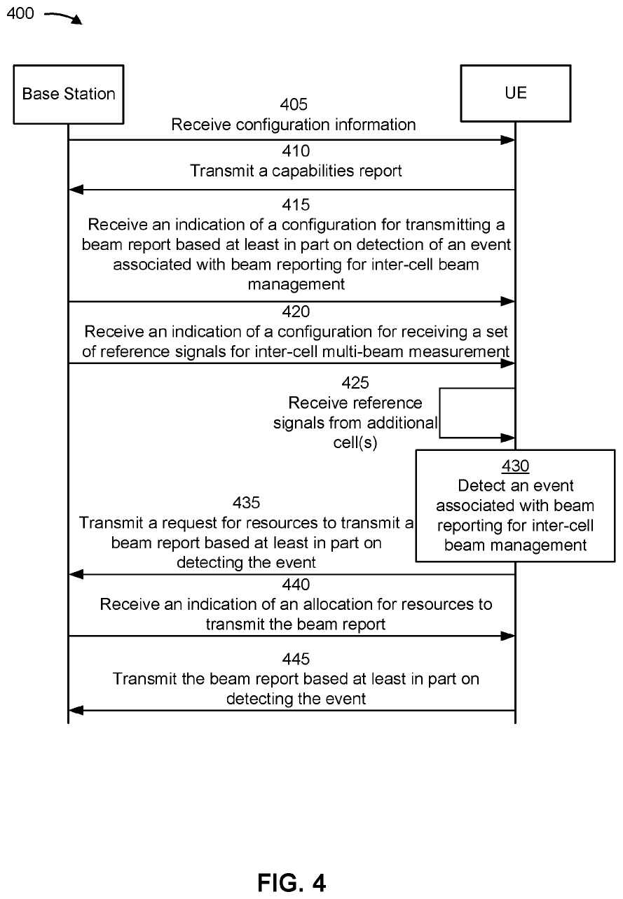

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

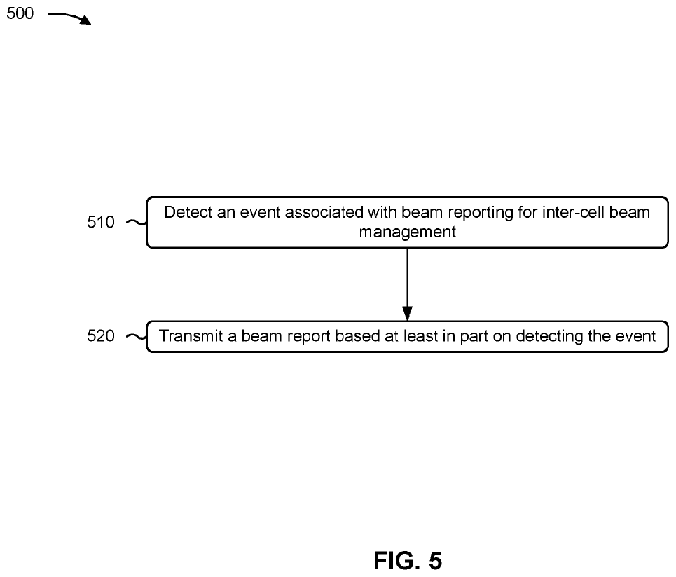

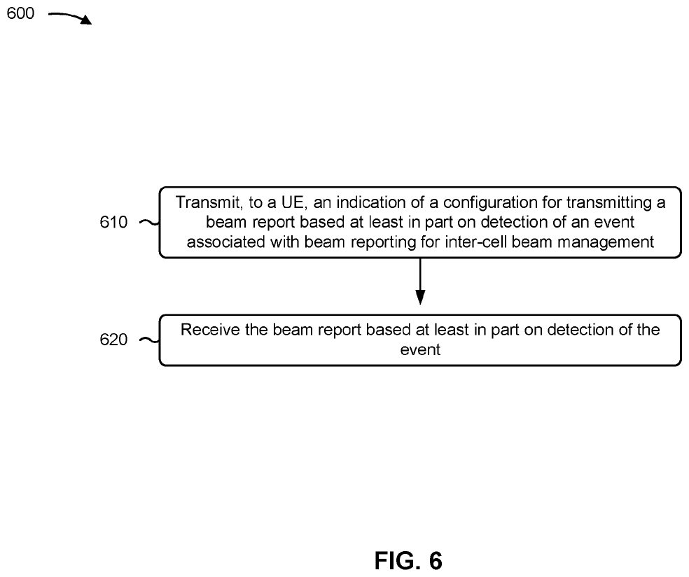

The controller/processor 240 of the base station 110, the controller/processor 280 of the UE 120, and/or any other component(s) of FIG. 2 may perform one or more techniques associated with beam reporting for inter-cell beam management, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for detecting an event associated with beam reporting for inter-cell beam management, and/or means for transmitting a beam report based at least in part on detecting the event. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, an indication of a configuration for transmitting a beam report based at least in part on detection of an event associated with beam reporting for inter-cell beam management, and/or means for receiving the beam report based at least in part on detection of the event. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

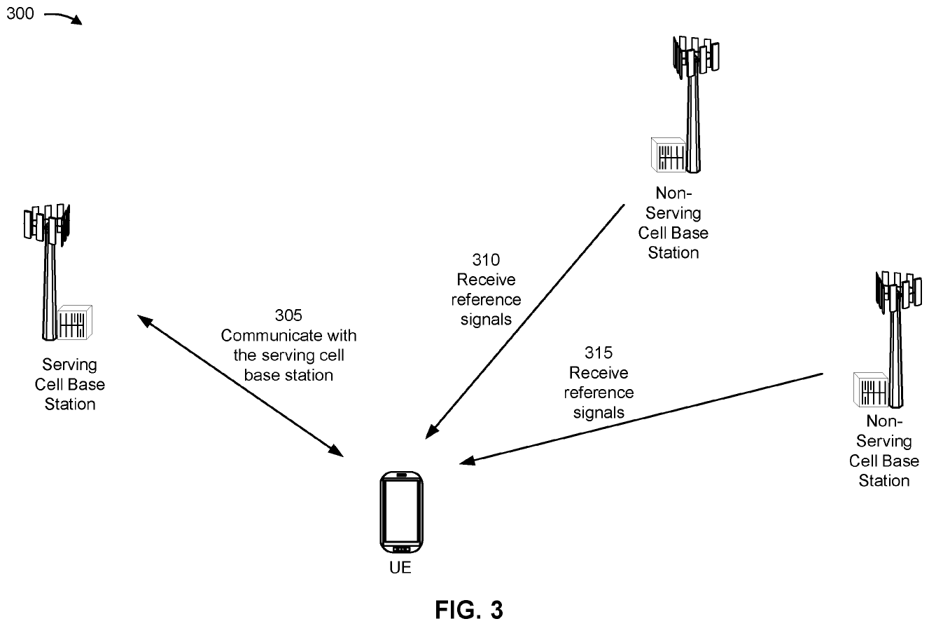

FIG. 3 is a diagram illustrating an example 300 of receiving reference signals from non-serving cells, in accordance with the present disclosure. As shown in FIG. 3, a UE (e.g., UE 120) may communicate with a serving cell base station (e.g., base station 110) and one or more non-serving cell base stations (e.g., base stations 110) (collectively referred to as the “base stations”). The base stations and the UE may be part of one or more wireless networks (e.g., wireless network 100) and the non-serving cell base stations may have a same physical cell identification (PCI) as the serving cell base station or may have one or more different PCIs from the serving cell base station. The UE and the serving cell base station may have established a wireless connection prior to operations shown in FIG. 3.

As shown in FIG. 3, and by reference number 305, the UE may communicate with (e.g., transmit signaling to or receive signaling from) the serving cell base station. For example, the UE may communicate with the serving cell base station using one or more beams of the UE (e.g., associated with different transmission configuration indicator (TCI) states).

In some networks, the UE may monitor reference signals (e.g., synchronization signal blocks (SSBs) and/or channel state information (CSI) reference signals (CSI-RSs) from non-serving cells to identify mobility metrics (e.g., to determine that a handover may improve a connection to a wireless network), to identify multi-TRP opportunities, to perform beam management via the non-serving cells, and/or to obtain timing information from the non-serving cells.

As shown by reference number 310, the UE may receive, and a non-serving cell base station may transmit, reference signals for beam management and/or mobility management, among other examples. As shown by reference number 315, the UE may receive, and an additional non-serving cell base station may transmit, reference signals for beam management and/or mobility management, among other examples.

As indicated above, FIG. 3 is provided as an example. Other examples may differ from what is described with regard to FIG. 3.

As described in connection with FIG. 3, a UE may obtain measurements of reference signals from the non-serving cell base stations (e.g., having different PCIs from a PCI of the serving cell base station). However, the UE may be unaware of how to report the measurements of the reference signals from the non-serving cell base stations. For example, the UE may be unaware of when to transmit a report of the measurements. Reporting after each measurement may consume processing, communication, network, and/or power resources to transmit the report even when the report is unlikely to cause a change in subsequent communications (e.g., when the report indicates that a current configuration with the serving cell base station is a most efficient configuration). Additionally, or alternatively, the UE may be unaware of information to include in the report of the measurements. For example, the UE may be unaware of what measurements to include in the report. Including each measurement may consume processing, communication, network, and/or power resources to have an unnecessarily large payload for the report.

In some aspects described herein, a UE may measure one or more reference signals from multiple beams (e.g., layer 1-RSRP multi-beam measurements) and report measurements to a base station. The UE may transmit the report using layer 1 reporting (e.g., reporting within uplink control information (UCI)) and/or layer 2 reporting (e.g., reporting within one or more medium access control (MAC) control elements (MAC CEs). In some aspects, the UE may transmit the report based at least in part on detecting an event associated with beam reporting for inter-cell beam management. The inter-cell beam management may include inter-cell multi-TRP management.

In some aspects, the UE may report information associated with beams (or reference signal index(es) associated with and/or representing beams) of different PCI and/or a corresponding beam metric (e.g., RSRP) in the UCI or the one or more MAC CEs. The UE may report the information based at least in part on a configuration from a base station or other network device and/or based at least in part on a communication protocol. In some aspects, the UE may report information associated with beams of a same PCI in a single reporting instance. In some aspects, the UE may report information associated with beams of different PCI in a single reporting instance. In some aspects, the UE may include information associated with beams of only non-serving cell PCIs in a single reporting instance. In some aspects, the UE may include information associated with beams of only non-activated cell PCIs (e.g., non-serving cell PCIs, among other examples) in a single reporting instance. In some aspects, the UE may include information associated with beams of both a serving cell PCI and non-serving cell PCIs in a single reporting instance. In some aspects, the UE may report the beams of PCIs and indicate the PCIs to the base station or other network device. In some aspects, the UE may be configured to report the beams of PCIs, and the PCIs to be reported are configured by the base station or other network device.

In some aspects, the UE may indicate a request of multi-beam reporting for inter-cell beam management and/or inter-cell multi-TRP, receive an indication of an allocation of resources for transmitting a report for inter-cell beam management and/or inter-cell multi-TRP, and then transmit the report (e.g., a two-step report). In some aspects, the UE may indicate a request of multi-beam reporting for inter-cell beam management and/or inter-cell multi-TRP, and then transmit a report for inter-cell beam management and/or inter-cell multi-TRP in a predetermined resource allocation (e.g., PUCCH or PUSCH). For example, the request may be a single-bit event indicator (e.g., within a scheduling request). The UE may transmit the single-bit event indicator within, for example, a dedicated physical uplink control channel (PUCCH) scheduling request or a physical random access channel (PRACH) message, among other examples.

In some aspects, the request may be a multi-bit indicator. The UE may transmit the multi-bit indicator via UCI carried in a PUCCH or a physical uplink shared channel (PUSCH) or by a MAC CE carried in a PUSCH, among other examples. In some aspects, the multi-bit indicator may indicate additional information associated with the inter-cell beam management and/or inter-cell multi-TRP, such as a CSI report configuration identification that is to be applied for the report. Additionally, or alternatively, the multi-bit indicator may indicate at least a PCI for which the UE requests to provide information (e.g., for inter-cell beam management and/or inter-cell multi-TRP).

In some aspects, the UE may be configured with periodical PUCCH occasions for transmitting the UCI that includes the single-bit event indicator or the multi-bit indicator. In some aspects, the UE may receive a configuration of a periodicity and/or time offset of the PUCCH occasions. The periodicity may be based at least in part on a likelihood that an event may occur (e.g., a low periodicity based at least in part on a high likelihood that the event may occur or a high periodicity based at least in part on a low likelihood that the event may occur, among other examples). The UE may cancel the PUCCH transmission if the event is not detected.

In some aspects, the UE may be configured with a set of periodical or semi-persistent reference signals (e.g., SSBs or CSI-RSs) for inter-cell multi-beam measurement. The reference signals may have a same PCI identification or may have different PCI identifications. For SSB reference signals, an SSB may have a same or different PCI from a serving cell PCI. For CSI-RS reference signals, a quasi-co-located (QCL) resource reference signal (e.g., of the CSI-RS reference signals) or root QCL resource reference signal (e.g., of the CSI-RS reference signals) may be an SSB of a same or different PCI from the serving cell PCI. In some aspects, a maximum number of different PCIs in the set of reference signals is subject to a UE capability.

In some aspects, the UE may be configured with a single channel measurement resource set of resource signals (RSs) associated with different PCIs for a beam report in inter-cell multi-beam measurement. In some aspects, the UE may be configured with a single channel measurement resource set of RSs associated with the same PCI for a beam report in inter-cell multi-beam measurement. In some aspects, the UE may be configured with multiple channel measurement resource sets of RSs for a beam report in inter-cell multi-beam measurement, where the RSs in one set are associated with a same PCI value, and different CMR sets are associated with different PCI values.

In some aspects, the beam report for inter-cell multi-beam measurement may include information for up to a number of N beams, and up to a number of M serving cell PCIs in a single reporting instance. In some aspects, the value of N and M may be based on a configuration by the base station, a communication protocol, and/or may be subject to a UE capability.

In some aspects, the UE may trigger the report for inter-cell multi-beam measurement when a condition is satisfied. The condition may be satisfied based at least in part on a beam quality of at least one reported cell (e.g., a reported non-serving cell or a reporting serving cell, among other examples) being better than a reference beam quality, or based at least in part on beam qualities of all reported cells (e.g., all reported non-serving cells or all reporting serving cells, among other examples) being better than the reference beam quality, among other examples. In some aspects, for multiple beams in a cell, the beam quality used as a reference beam quality or a reported beam quality to determine if the condition is satisfied may include an average value of the beam qualities, a minimum value of the beam qualities, or a maximum value of the beam qualities of multiple beams for the cell of a same PCI ID. In some aspects, the beam quality may be measured based at least in part on filtering and/or averaging multiple measurement samples.

In some aspects, the reference beam quality may be based at least in part on a beam quality of an activated (e.g., non-serving) cell, a beam quality of the serving cell, a beam quality of any of the serving cell and activated non-serving cells, among other examples. In some aspects, the reference beam quality may be based at least in part on a preconfigured beam quality (e.g., an RSRP threshold) or a beam quality related to a previous beam report for inter-cell multi-beam measurement.

In some aspects, the condition may be satisfied based at least in part on a beam quality of at least one reported beam being better than the reference beam quality or based at least in part on the beam quality of the at least one reported beam being better than the reference beam quality by a threshold amount (e.g., a preconfigured threshold offset).

In some aspects, the UE may trigger the beam report for inter-cell beam management or inter-cell multi-TRP when any of beam among the measured beams with topic beam qualities has changed (e.g., by more than a preconfigured threshold amount). In some aspects, UE may trigger the beam report for inter-cell beam management or inter-cell multi-TRP when any of cell among the measured cells with topic beam qualities has changed (e.g., by more than a preconfigured threshold amount). In some aspects, UE may trigger the beam report for inter-cell beam management or inter-cell multi-TRP when the cells with topic beam qualities has changed (e.g., by more than a preconfigured threshold amount). In some aspects, the UE may trigger the beam report for inter-cell beam management or inter-cell multi-TRP when any non-serving cell is to be activated or added in a cell list. In some aspects, the UE may trigger the beam report for inter-cell beam management or inter-cell multi-TRP when any non-serving cell is to be removed or deactivated in a cell list. In some aspects, the UE may trigger the beam report for inter-cell beam management or inter-cell multi-TRP when any non-serving cell is to be replaced with a new non-serving cell in a cell list. In some aspects, the cell list may be a configured cell list, or a list of activated cells, among other examples.

Based at least in part on the UE transmitting the report based at least in part on detecting an event associated with beam reporting for inter-cell beam management, the UE may conserve processing, communication, network, and/or power resources that may have otherwise been consumed to transmit the report (e.g., after each measurement) even when the report is unlikely to cause a change in subsequent communications (e.g., when the report indicates that a current configuration with the serving cell base station is a most efficient configuration). Additionally, or alternatively, the UE may be configured to include a subset of information associated with the measurements in the report. In this way, the UE may conserve communication and/or network resources that may have otherwise been used to transmit an unnecessarily large payload for the report.

FIG. 4 is a diagram illustrating an example 400 associated with beam reporting for inter-cell beam management, in accordance with the present disclosure. As shown in FIG. 4, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 4. The base station and the UE may be associated with a first cell (e.g., a serving cell).

As shown by reference number 405, the base station may transmit, and the UE may receive, configuration information. In some aspects, the UE may receive the configuration information via one or more of radio resource control (RRC) signaling, one or more MAC CEs, and/or downlink control information (DCI), among other examples. In some aspects, the configuration information may include an indication of one or more configuration parameters (e.g., already known to the UE) for selection by the UE, or explicit configuration information for the UE to use to configure the UE, among other examples.

In some aspects, the configuration information may indicate that the UE is to receive an indication of a configuration for transmitting a beam report based at least in part on detection of an event associated with beam reporting for inter-cell beam management. In some aspects, the configuration information may indicate that the UE is to receive an indication of a configuration for receiving a set of reference signals for inter-cell multi-beam measurement. In some aspects, the configuration information may indicate that the UE is to transmit a beam report based at least in part on detecting an event associated with beam reporting for inter-cell beam management. In some aspects, the configuration information may indicate that the UE is to transmit a request for resources to transmit the report based at least in part on detecting the event.

The UE may configure itself based at least in part on the configuration information. In some aspects, the UE may be configured to perform one or more operations described herein based at least in part on the configuration information.

As shown by reference number 410, the UE may transmit, and the base station may receive, a capabilities report. The capabilities report may indicate UE support for one or more parameters associated with inter-cell beam management and/or inter-cell multi-beam measurement. For example, the capabilities report may indicate a number of reference signals that the UE is capable of including in a report and/or a number of periodic or semi-persistent reference signals that the UE is capable of measuring for inter-cell multi-beam measurement, among other examples.

As shown by reference number 415, the UE may receive, and the base station may transmit, an indication of a configuration for transmitting the beam report based at least in part on detection of the event associated with beam reporting for inter-cell beam management. In some aspects, the configuration for transmitting the beam report may indicate resources for transmitting the report, parameters for an event that is configured to trigger transmission of the report, and/or parameters that indicate what information to include in the report, among other examples. In some aspects, the configuration for transmitting the beam report may indicate a process for determining resources for transmitting the report. For example, the configuration for transmitting the beam report may indicate that the UE is to use a two-step process for transmitting the report. The two-step process may include transmitting a scheduling request (e.g., using a configuration indicated by the base station) for resources to transmit a payload of the report.

As shown by reference number 420, the UE may receive, and the base station may transmit, an indication of a configuration for receiving a set of reference signals for inter-cell multi-beam measurement. In some aspects, the configuration for receiving the set of reference signals for inter-cell multi-beam measurement may indicate a configuration (e.g., resources allocated) for receiving a set of periodic or semi-persistent reference signals for inter-cell multi-beam measurement. The set of reference signals may be associated with different beams, different base stations, different TRPs, and/or different PCIs.

As shown by reference number 425, the UE may receive reference signals from one or more additional cells. For example, the UE may receive the reference signals from one or more non-serving cells, one or more active cells (e.g., active non-serving cells), and/or one or more not activated cells (e.g., inactive non-serving cells). In some aspects, the UE may receive the reference signals using beams (e.g., QCL information and/or TCI states, among other examples) associated with different PCIs and/or associated with the same PCI (e.g., the same PCI associated with other beams and/or the same PCI associated with a beam used for communications with the base station). In some aspects, a number of the reference signals that the UE receives is based at least in part on a capability of the UE and/or the capabilities report described in connection with reference number 410.

In some aspects, the reference signals (e.g., the set of periodic or semi-persistent reference signals for inter-cell multi-beam measurement) include one or more SSBs having a same PCI as a serving cell PCI, and/or one or more SSBs having a different PCI from the serving cell PCI, among other examples. In some aspects, the reference signals include one or more CSI-RSs associated with a first QCL resource or a first root QCL resource that is a first SSB having the same PCI as the serving cell PCI, or one or more CSI RSs associated with a second QCL resource or a second root QCL resource that is a second SSB having a different PCI from the serving cell PCI, among other examples.

As shown by reference number 430, the UE may detect an event associated with beam reporting for inter-cell beam management. In some aspects, the event may include identification of one or more non-serving cells (e.g., at least one non-serving cell) having a beam quality that is greater than a reference beam quality (e.g., by a threshold amount) or identification of all reported cells as having beam qualities that are greater than the reference beam quality (e.g., by a threshold amount), among other examples. In some aspects, the threshold amount may be based at least in part on an indication within configuration information received as shown in connection with reference numbers 405 and/or 415 and/or may be based at least in part on a communication protocol, among other examples.

In some aspects, the beam qualities include an average beam quality of multiple beams having a same PCI (e.g., to be indicated in the report), a minimum beam quality of the multiple beams having the same PCI, a maximum beam quality of the multiple beams having the same PCI, or sample beam qualities of multiple measurements of sets of beam qualities (e.g., beam qualities sampled at one or more times and/or from one or more beams of the multiple beams), among other examples.

In some aspects, the reference beam quality includes a beam quality of an activated non-serving cell, a beam quality of a serving cell, a configured beam quality threshold, or a beam quality associated with a previous beam report, among other examples.

As shown by reference number 435, the UE may transmit, and the base station may receive, a request for resources to transmit a beam report based at least in part on detecting the event. In some aspects, the request for resources may include a request to transmit the beam report that includes measurement-based indications for beams associated with different PCIs. For example, the request for resources may indicate that the request is associated with the beam report that includes measurement-based indications for beams associated with different PCIs.

In some aspects, the request for resources may include a single-bit indication. For example, the UE may transmit the request for resources as a single-bit indication (e.g., a scheduling request) via a dedicated PUCCH-SR or via a PRACH.

In some aspects, the request for resources may include a multi-bit indication. For example, the UE may transmit the request for resources as a multi-bit indication within UCI, within a periodic PUCCH occasion, and/or within one or more MAC CEs, among other examples.

In some aspects, the request for resources may include an indication of a CSI report configuration identification for the beam report. In some aspects, the request for resources may include one or more PCIs for which the UE is to report within the beam report.

As shown by reference number 440, the UE may receive, and the base station may transmit, an indication of an allocation for resources to transmit the beam report. In some aspects, the base station may allocate an amount of resources that is based at least in part on the request for resources, a configured amount of resources (e.g., based at least in part on a communication protocol, among other examples), the capabilities report, the indication of the configuration for transmitting the beam report, and/or the indication of the configuration for receiving the set of reference signals, among other examples.

As shown by reference number 445, the UE may transmit, and the base station may receive, the beam report based at least in part on detection of the event. In some aspects, the UE may transmit the report via UCI (e.g., layer 1 reporting using resources of a PUCCH and/or a PUSCH, among other examples). In some aspects, the UE may transmit the report via one or more MAC CEs (e.g., layer 2 reporting).

In some aspects, the UE may transmit the beam report further based at least in part on transmitting the request for resources and/or receiving the indication of the allocation for resources. In some aspects, the UE may transmit the beam report independently from (e.g., in the absence of) transmitting the request for resources and/or receiving the indication of the allocation for resources. In some aspects, the UE may transmit the beam report using periodic and/or semiconductor-persistent resources.

In some aspects, the beam report may include measurement-based indications for beams associated with the same PCI and/or different PCIs. In some aspects, the measurement-based indications may include indications of RSRP, signal-to-noise-ratio (SNR), and/or signal-to-interference-plus-noise-ratio (SINR), among other examples.

In some aspects, the beam report includes measurement-based indications for a number of beams and/or for a number of non-serving cell PCIs in a single reporting instance. In some aspects, the number of beams and/or the number of non-serving cell PCIs are based at least in part on a configuration indicated by a network device (e.g., the base station) and/or a capability of the UE. In some aspects, an instance of the beam report includes information associated with only beams having a same PCI or beams having different PCIs (e.g., based at least in part on a configuration or a capability of the UE, among other examples). In some aspects, the beam report may include information associated with beams having a non-serving cell PCI, beams having an inactive non-serving cell PCI, and/or beams having a serving cell PCI, among other examples (e.g., based at least in part on a configuration or a capability of the UE, among other examples).

Based at least in part on the UE transmitting the report based at least in part on detecting an event associated with beam reporting for inter-cell beam management, the UE may conserve processing, communication, network, and/or power resources that may have otherwise been consumed to transmit the report (e.g., after each measurement) when the report is unlikely to cause a change in subsequent communications (e.g., when the report indicates that a current configuration with the serving cell base station is a most efficient configuration). Additionally, or alternatively, the UE may be configured to include a subset of information associated with the measurements in the report. In this way, the UE may conserve communication and/or network resources that may have otherwise been used to transmit an unnecessarily large payload for the report.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with beam reporting for inter-cell beam management.

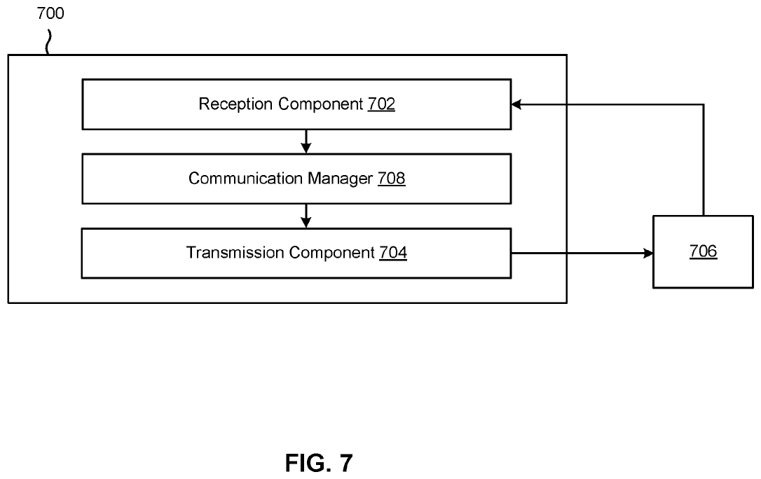

As shown in FIG. 5, in some aspects, process 500 may include detecting an event associated with beam reporting for inter-cell beam management (block 510). For example, the UE (e.g., using communication manager 140 and/or communication manager 708, depicted in FIG. 7) may detect an event associated with beam reporting for inter-cell beam management, as described above.

As further shown in FIG. 5, in some aspects, process 500 may include transmitting a beam report based at least in part on detecting the event (block 520). For example, the UE (e.g., using communication manager 140 and/or transmission component 704, depicted in FIG. 7) may transmit a beam report based at least in part on detecting the event, as described above.

Process 500 may include additional aspects, such as any single aspect or any combination of aspects described below and/or in connection with one or more other processes described elsewhere herein.

In a first aspect, the beam report includes measurement-based indications for beams associated with different PCIs.

In a second aspect, alone or in combination with the first aspect, the beam report comprises the measurement-based indications for a number of beams and for a number of non-serving cell PCIs in a single reporting instance, and one or more of the number of beams or the number of non-serving cell PCIs is based at least in part on one or more of a configuration indicated by a network device or a capability of the UE.

In a third aspect, alone or in combination with one or more of the first and second aspects, transmitting the beam report comprises transmitting the beam report via UCI, or transmitting the beam report via one or more MAC CEs.

In a fourth aspect, alone or in combination with one or more of the first through third aspects, an instance of the beam report includes information associated with only beams having a same PCI, or beams having different PCIs.

In a fifth aspect, alone or in combination with one or more of the first through fourth aspects, the beam report includes information associated with one or more of beams having a non-serving cell PCI, beams having an inactive non-serving cell PCI, or beams having a serving cell PCI.

In a sixth aspect, alone or in combination with one or more of the first through fifth aspects, process 500 includes transmitting a request for resources to transmit the beam report.

In a seventh aspect, alone or in combination with one or more of the first through sixth aspects, the request for the resources comprises a request to transmit the beam report that includes measurement-based indications for beams associated with different PCIs.

In an eighth aspect, alone or in combination with one or more of the first through seventh aspects, the request for the resources comprises a single bit indication, a multi-bit indication within uplink control information, a multi-bit indication within a periodic physical uplink control channel occasion, a multi-bit indication within a MAC CE, an indication of a CSI report configuration identification for the beam report, or an indication of a PCI that the UE is to report within the beam report.

In a ninth aspect, alone or in combination with one or more of the first through eighth aspects, process 500 includes receiving an indication of a configuration for receiving a set of periodic or semi-persistent reference signals for inter-cell multi-beam measurement.

In a tenth aspect, alone or in combination with one or more of the first through ninth aspects, the set of periodic or semi-persistent reference signals for inter-cell multi-beam measurement comprises one or more of one or more SSBs having a same PCI as a serving cell PCI, one or more SSBs having a different PCI from the serving cell PCI, one or more CSI-RSs associated with a first quasi-co-location (QCL) resource or a first root QCL resource that is a first SSB having the same PCI as the serving cell PCI, or one or more CSI RSs associated with a second QCL resource or a second root QCL resource that is a second SSB having a different PCI from the serving cell PCI.

In an eleventh aspect, alone or in combination with one or more of the first through tenth aspects, the set of periodic or semi-persistent reference signals for inter-cell multi-beam measurement comprises a number of reference signals that is based at least in part on a capability of the UE.

In a twelfth aspect, alone or in combination with one or more of the first through eleventh aspects, the event associated with beam reporting for inter-cell beam management comprises one or more of identification of one or more non-serving cells having a beam quality that is greater than a reference beam quality, or identification of all reported cells as having beam qualities that are greater than the reference beam quality.

In a thirteenth aspect, alone or in combination with one or more of the first through twelfth aspects, the beam qualities comprise one or more of an average beam quality of multiple beams having a same PCI, a minimum beam quality of the multiple beams having the same PCI, a maximum beam quality of the multiple beams having the same PCI, or sampling beam qualities of multiple measurements of sets of beam qualities.

In a fourteenth aspect, alone or in combination with one or more of the first through thirteenth aspects, the reference beam quality comprises one or more of a beam quality of an activated non-serving cell, a beam quality of a serving cell, a configured beam quality threshold, or a beam quality associated with a previous beam report

In a fifteenth aspect, alone or in combination with one or more of the first through fourteenth aspects, the event associated with beam reporting for inter-cell beam management comprises one or more of identification of one or more non-serving cells having a beam quality that is greater than the reference beam quality by a threshold amount, or identification of all reported cells as having beam qualities that are greater than the reference beam quality by the threshold amount.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with beam reporting for inter-cell beam management.

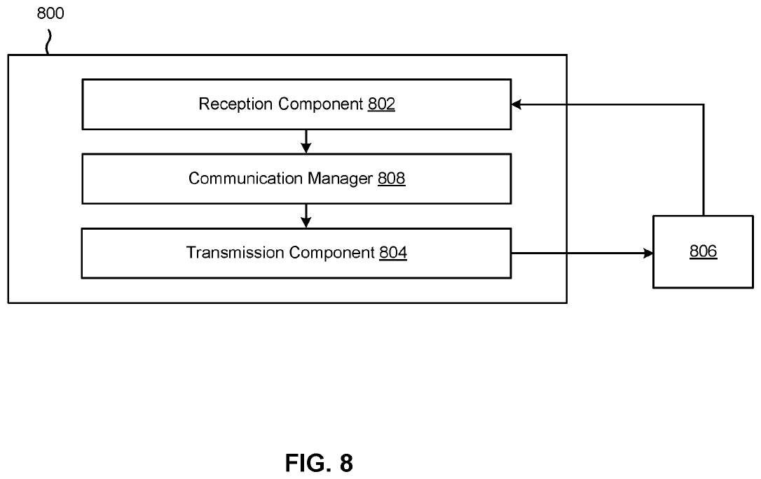

As shown in FIG. 6, in some aspects, process 600 may include transmitting, to a UE, an indication of a configuration for transmitting a beam report based at least in part on detection of an event associated with beam reporting for inter-cell beam management (block 610). For example, the base station (e.g., using communication manager 150 and/or transmission component 804, depicted in FIG. 8) may transmit, to a UE, an indication of a configuration for transmitting a beam report based at least in part on detection of an event associated with beam reporting for inter-cell beam management, as described above.

As further shown in FIG. 6, in some aspects, process 600 may include receiving the beam report based at least in part on detection of the event (block 620) For example, the base station (e.g., using communication manager 150 and/or reception component 802, depicted in FIG. 8) may receive the beam report based at least in part on detection of the event, as described above.

Process 600 may include additional aspects, such as any single aspect or any combination of aspects described below and/or in connection with one or more other processes described elsewhere herein.

In a first aspect, the beam report includes measurement-based indications for beams associated with different PCIs.

In a second aspect, alone or in combination with the first aspect, the beam report comprises the measurement-based indications for a number of beams and for a number of non-serving cell PCIs in a single reporting instance, and one or more of the number of beams or the number of non-serving cell PCIs is based at least in part on one or more of a configuration indicated by a network device or a capability of the UE.

In a third aspect, alone or in combination with one or more of the first and second aspects, receiving the beam report comprises receiving the beam report via uplink control information, or receiving the beam report via one or more MAC CEs.

In a fourth aspect, alone or in combination with one or more of the first through third aspects, an instance of the beam report includes information associated with only beams having a same PCI, or beams having different PCIs.

In a fifth aspect, alone or in combination with one or more of the first through fourth aspects, the beam report includes information associated with one or more of beams having a non-serving cell PCI, beams having an inactive non-serving cell PCI, or beams having a serving cell PCI.

In a sixth aspect, alone or in combination with one or more of the first through fifth aspects, process 600 includes receiving a request for resources to transmit the beam report.

In a seventh aspect, alone or in combination with one or more of the first through sixth aspects, the request for the resources comprises a request to transmit the beam report that includes measurement-based indications for beams associated with different PCIs.

In an eighth aspect, alone or in combination with one or more of the first through seventh aspects, the request for the resources comprises a single bit indication, a multi-bit indication within uplink control information, a multi-bit indication within a periodic physical uplink control channel occasion, a multi-bit indication within a MAC CE, an indication of a CSI report configuration identification for the beam report, or an indication of a PCI that the UE is to report within the beam report.

In a ninth aspect, alone or in combination with one or more of the first through eighth aspects, process 600 includes transmitting an indication of a configuration for receiving a set of periodic or semi-persistent reference signals for inter-cell multi-beam measurement.

In a tenth aspect, alone or in combination with one or more of the first through ninth aspects, the set of periodic or semi-persistent reference signals for inter-cell multi-beam measurement comprises one or more of one or more SSBs having a same PCI as a serving cell PCI, one or more SSBs having a different PCI from the serving cell PCI, one or more CSI-RSs associated with a first QCL resource or a first root QCL resource that is a first SSB having the same PCI as the serving cell PCI, or one or more CSI RSs associated with a second QCL resource or a second root QCL resource that is a second SSB having a different PCI from the serving cell PCI.

In an eleventh aspect, alone or in combination with one or more of the first through tenth aspects, the set of periodic or semi-persistent reference signals for inter-cell multi-beam measurement comprises a number of reference signals that is based at least in part on a capability of the UE.

In a twelfth aspect, alone or in combination with one or more of the first through eleventh aspects, the event associated with beam reporting for inter-cell beam management comprises one or more of identification of one or more non-serving cells having a beam quality that is greater than a reference beam quality, or identification of all reported cells as having beam qualities that are greater than the reference beam quality.

In a thirteenth aspect, alone or in combination with one or more of the first through twelfth aspects, the beam qualities comprise one or more of an average beam quality of multiple beams having a same PCI, a minimum beam quality of the multiple beams having the same PCI, a maximum beam quality of the multiple beams having the same PCI, or sampling beam qualities of multiple measurements of sets of beam qualities.

In a fourteenth aspect, alone or in combination with one or more of the first through thirteenth aspects, the reference beam quality comprises one or more of a beam quality of an activated non-serving cell, a beam quality of a serving cell, a configured beam quality threshold, or a beam quality associated with a previous beam report.

In a fifteenth aspect, alone or in combination with one or more of the first through fourteenth aspects, the event associated with beam reporting for inter-cell beam management comprises one or more of identification of one or more non-serving cells having a beam quality that is greater than the reference beam quality by a threshold amount, or identification of all reported cells as having beam qualities that are greater than the reference beam quality by the threshold amount.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708 (e.g., the communication manager 140). The communication manager 708 may include a determination component and/or a detection component, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 708 may detect an event associated with beam reporting for inter-cell beam management. The transmission component 704 may transmit a beam report based at least in part on detecting the event.

The transmission component 704 may transmit a request for resources to transmit the beam report.

The reception component 702 may receive an indication of a configuration for receiving a set of periodic or semi-persistent reference signals for inter-cell multi-beam measurement.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808 (e.g., the communication manager 150). The communication manager 808 may include a determination component and/or a scheduling component, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit, to a UE, an indication of a configuration for transmitting a beam report based at least in part on detection of an event associated with beam reporting for inter-cell beam management. The reception component 802 may receive the beam report based at least in part on detection of the event.

The reception component 802 may receive a request for resources to transmit the beam report.

The transmission component 804 may transmit an indication of a configuration for receiving a set of periodic or semi-persistent reference signals for inter-cell multi-beam measurement.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: detecting an event associated with beam reporting for inter-cell beam management; and transmitting a beam report based at least in part on detecting the event.

Aspect 2: The method of Aspect 1, wherein the beam report includes measurement-based indications for beams associated with different physical cell identifications.

Aspect 3: The method of Aspect 2, wherein the beam report comprises the measurement-based indications for a number of beams and for a number of non-serving cell physical cell identifications (PCIs) in a single reporting instance, and wherein one or more of the number of beams or the number of non-serving cell PCIs is based at least in part on one or more of a configuration indicated by a network device or a capability of the UE.

Aspect 4: The method of any of Aspects 1-3, wherein transmitting the beam report comprises: transmitting the beam report via uplink control information, or transmitting the beam report via one or more medium access control control elements.

Aspect 5: The method of any of Aspects 1-4, wherein an instance of the beam report includes information associated with: only beams having a same physical cell identification, or beams having different physical cell identifications.

Aspect 6: The method of any of Aspects 1-5, wherein the beam report includes information associated with one or more of: beams having a non-serving cell physical cell identification, beams having an inactive non-serving cell physical cell identification, or beams having a serving cell physical cell identification.

Aspect 7: The method of any of Aspects 1-6, further comprising: transmitting a request for resources to transmit the beam report.

Aspect 8: The method of Aspect 7, wherein the request for the resources comprises: a request to transmit the beam report that includes measurement-based indications for beams associated with different physical cell identifications.

Aspect 9: The method of any of Aspects 7 or 8, wherein the request for the resources comprises: a single bit indication, a multi-bit indication within uplink control information, a multi-bit indication within a periodic physical uplink control channel occasion, a multi-bit indication within a medium access control control element, an indication of a channel state information report configuration identification for the beam report, or an indication of a physical cell identification that the UE is to report within the beam report.

Aspect 10: The method of any of Aspects 1-9, further comprising: receiving an indication of a configuration for receiving a set of periodic or semi-persistent reference signals for inter-cell multi-beam measurement.

Aspect 11: The method of Aspect 10, wherein the set of periodic or semi-persistent reference signals for inter-cell multi-beam measurement comprises one or more of: one or more synchronization signal blocks (SSBs) having a same physical cell identification (PCI) as a serving cell PCI, one or more SSBs having a different PCI from the serving cell PCI, one or more channel state information (CSI) reference signals (RSs) associated with a first QCL resource or a first root QCL resource that is a first SSB having the same PCI as the serving cell PCI, or one or more CSI RSs associated with a second QCL resource or a second root QCL resource that is a second SSB having a different PCI from the serving cell PCI.

Aspect 12: The method of any of Aspects 10 or 11, wherein the set of periodic or semi-persistent reference signals for inter-cell multi-beam measurement comprises: a number of reference signals that is based at least in part on a capability of the UE.

Aspect 13: The method of any of Aspects 1-12, wherein the event associated with beam reporting for inter-cell beam management comprises one or more of: identification of one or more non-serving cells having a beam quality that is greater than a reference beam quality, or identification of all reported cells as having beam qualities that are greater than the reference beam quality.

Aspect 14: The method of Aspect 13, wherein the beam qualities comprise one or more of: an average beam quality of multiple beams having a same physical cell identification (PCI), a minimum beam quality of the multiple beams having the same PCI, a maximum beam quality of the multiple beams having the same PCI, or sample beam qualities of multiple measurements of sets of beam qualities.

Aspect 15: The method of any of Aspects 13 or 14, wherein the reference beam quality comprises one or more of: a beam quality of an activated non-serving cell, a beam quality of a serving cell, a configured beam quality threshold, or a beam quality associated with a previous beam report.

Aspect 16: The method of any of Aspects 13-15, wherein the event associated with beam reporting for inter-cell beam management comprises one or more of: identification of one or more non-serving cells having a beam quality that is greater than the reference beam quality by a threshold amount, or identification of all reported cells as having beam qualities that are greater than the reference beam quality by the threshold amount.

Aspect 17: A method of wireless communication performed by a base station, comprising: transmitting, to a user equipment (UE), an indication of a configuration for transmitting a beam report based at least in part on detection of an event associated with beam reporting for inter-cell beam management; and receiving the beam report based at least in part on detection of the event.

Aspect 18: The method of Aspect 17, wherein the beam report includes measurement-based indications for beams associated with different physical cell identifications.

Aspect 19: The method of Aspect 18, wherein the beam report comprises the measurement-based indications for a number of beams and for a number of non-serving cell physical cell identifications (PCIs) in a single reporting instance, and wherein one or more of the number of beams or the number of non-serving cell PCIs is based at least in part on one or more of a configuration indicated by a network device or a capability of the UE.

Aspect 20: The method of any of Aspects 17-19, wherein receiving the beam report comprises: receiving the beam report via uplink control information, or receiving the beam report via one or more medium access control control elements.

Aspect 21: The method of any of Aspects 17-20, wherein an instance of the beam report includes information associated with: only beams having a same physical cell identification, or beams having different physical cell identifications.

Aspect 22: The method of any of Aspects 17-21, wherein the beam report includes information associated with one or more of: beams having a non-serving cell physical cell identification, beams having an inactive non-serving cell physical cell identification, or beams having a serving cell physical cell identification.

Aspect 23: The method of any of Aspects 17-22, further comprising: receiving a request for resources to transmit the beam report.

Aspect 24: The method of Aspect 23, wherein the request for the resources comprises: a request to transmit the beam report that includes measurement-based indications for beams associated with different physical cell identifications.

Aspect 25: The method of any of Aspects 23 or 24, wherein the request for the resources comprises: a single bit indication, a multi-bit indication within uplink control information, a multi-bit indication within a periodic physical uplink control channel occasion, a multi-bit indication within a medium access control control element, an indication of a channel state information report configuration identification for the beam report, or an indication of a physical cell identification that the UE is to report within the beam report.

Aspect 26: The method of any of Aspects 17-25, further comprising: transmitting an indication of a configuration for receiving a set of periodic or semi-persistent reference signals for inter-cell multi-beam measurement.

Aspect 27: The method of Aspect 26, wherein the set of periodic or semi-persistent reference signals for inter-cell multi-beam measurement comprises one or more of one or more synchronization signal blocks (SSBs) having a same physical cell identification (PCI) as a serving cell PCI, one or more SSBs having a different PCI from the serving cell PCI, one or more channel state information (CSI) reference signals (RSs) associated with a first QCL resource or a first root QCL resource that is a first SSB having the same PCI as the serving cell PCI, or one or more CSI RSs associated with a second QCL resource or a second root QCL resource that is a second SSB having a different PCI from the serving cell PCI.

Aspect 28: The method of any of Aspects 26 or 27, wherein the set of periodic or semi-persistent reference signals for inter-cell multi-beam measurement comprises: a number of reference signals that is based at least in part on a capability of the UE.

Aspect 29: The method of any of Aspects 17-28, wherein the event associated with beam reporting for inter-cell beam management comprises one or more of: identification of one or more non-serving cells having a beam quality that is greater than a reference beam quality, or identification of all reported cells as having beam qualities that are greater than the reference beam quality.

Aspect 30: The method of Aspect 29, wherein the beam qualities comprise one or more of: an average beam quality of multiple beams having a same physical cell identification (PCI), a minimum beam quality of the multiple beams having the same PCI, a maximum beam quality of the multiple beams having the same PCI, or sample beam qualities of multiple measurements of sets of beam qualities.

Aspect 31: The method of any of Aspects 29 or 30, wherein the reference beam quality comprises one or more of: a beam quality of an activated non-serving cell, a beam quality of a serving cell, a configured beam quality threshold, or a beam quality associated with a previous beam report.

Aspect 32: The method of any of Aspects 29-31, wherein the event associated with beam reporting for inter-cell beam management comprises one or more of: identification of one or more non-serving cells having a beam quality that is greater than the reference beam quality by a threshold amount, or identification of all reported cells as having beam qualities that are greater than the reference beam quality by the threshold amount.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
detect an event associated with beam reporting for inter-cell beam management; and
transmit a beam report based at least in part on detecting the event.

2. The UE of claim 1, wherein the beam report includes measurement-based indications for beams associated with different physical cell identifications.

3. The UE of claim 2, wherein the beam report comprises the measurement-based indications for a number of beams and for a number of non-serving cell physical cell identifications (PCIs) in a single reporting instance, and
wherein one or more of the number of beams or the number of non-serving cell PCIs is based at least in part on one or more of a configuration indicated by a network device or a capability of the UE.

4. The UE of claim 1, wherein the one or more processors, to transmit the beam report, are configured to:
transmit the beam report via uplink control information, or
transmit the beam report via one or more medium access control control elements.

5. The UE of claim 1, wherein an instance of the beam report includes information associated with:
only beams having a same physical cell identification, or
beams having different physical cell identifications.

6. The UE of claim 1, wherein the beam report includes information associated with one or more of:
beams having a non-serving cell physical cell identification,
beams having an inactive non-serving cell physical cell identification, or
beams having a serving cell physical cell identification.

7. The UE of claim 1, wherein the one or more processors are further configured to:
transmit a request for resources to transmit the beam report.

8. The UE of claim 7, wherein the request for the resources comprises:
a request to transmit the beam report that includes measurement-based indications for beams associated with different physical cell identifications.

9. The UE of claim 7, wherein the request for the resources comprises:
a single bit indication,
a multi-bit indication within uplink control information,
a multi-bit indication within a periodic physical uplink control channel occasion,
a multi-bit indication within a medium access control control element,
an indication of a channel state information report configuration identification for the beam report, or
an indication of a physical cell identification that the UE is to report within the beam report.

10. The UE of claim 1, wherein the one or more processors are further configured to:
receive an indication of a configuration for receiving a set of periodic or semi-persistent reference signals for inter-cell multi-beam measurement.

11. The UE of claim 10, wherein the set of periodic or semi-persistent reference signals for inter-cell multi-beam measurement comprises one or more of:
one or more synchronization signal blocks (SSBs) having a same physical cell identification (PCI) as a serving cell PCI,
one or more SSBs having a different PCI from the serving cell PCI,
one or more channel state information (CSI) reference signals (RSs) associated with a first quasi-co-location (QCL) resource or a first root QCL resource that is a first SSB having the same PCI as the serving cell PCI, or
one or more CSI RSs associated with a second QCL resource or a second root QCL resource that is a second SSB having a different PCI from the serving cell PCI.

12. The UE of claim 10, wherein the set of periodic or semi-persistent reference signals for inter-cell multi-beam measurement comprises:
a number of reference signals that is based at least in part on a capability of the UE.

13. The UE of claim 1, wherein the event associated with beam reporting for inter-cell beam management comprises one or more of:
identification of one or more non-serving cells having a beam quality that is greater than a reference beam quality, or
identification of all reported cells as having beam qualities that are greater than the reference beam quality.

14. The UE of claim 13, wherein the beam qualities comprise one or more of:
an average beam quality of multiple beams having a same physical cell identification (PCI),
a minimum beam quality of the multiple beams having the same PCI,
a maximum beam quality of the multiple beams having the same PCI, or
sample beam qualities of multiple measurements of sets of beam qualities.

15. The UE of claim 13, wherein the reference beam quality comprises one or more of:
a beam quality of an activated non-serving cell,
a beam quality of a serving cell,
a configured beam quality threshold, or
a beam quality associated with a previous beam report.

16. The UE of claim 13, wherein the event associated with beam reporting for inter-cell beam management comprises one or more of:
identification of one or more non-serving cells having a beam quality that is greater than the reference beam quality by a threshold amount, or
identification of all reported cells as having beam qualities that are greater than the reference beam quality by the threshold amount.

17. A base station for wireless communication, comprising:
a memory; and
one or more processors, coupled to the memory, configured to:
transmit, to a user equipment (UE), an indication of a configuration for transmitting a beam report based at least in part on detection of an event associated with beam reporting for inter-cell beam management; and
receive the beam report based at least in part on detection of the event.

18. The base station of claim 17, wherein the beam report includes measurement-based indications for beams associated with different physical cell identifications.

19. The base station of claim 18, wherein the beam report comprises the measurement-based indications for a number of beams and for a number of non-serving cell physical cell identifications (PCIs) in a single reporting instance, and
wherein one or more of the number of beams or the number of non-serving cell PCIs is based at least in part on one or more of a configuration indicated by a network device or a capability of the UE.

20. The base station of claim 17, wherein an instance of the beam report includes information associated with:
only beams having a same physical cell identification, or
beams having different physical cell identifications.

21. The base station of claim 17, wherein the beam report includes information associated with one or more of:
beams having a non-serving cell physical cell identification,
beams having an inactive non-serving cell physical cell identification, or
beams having a serving cell physical cell identification.

22. The base station of claim 17, wherein the one or more processors are further configured to:
receive a request for resources to transmit the beam report.

23. The base station of claim 22, wherein the request for the resources comprises:
a single bit indication,
a multi-bit indication within uplink control information,
a multi-bit indication within a periodic physical uplink control channel occasion,
a multi-bit indication within a medium access control control element,
an indication of a channel state information report configuration identification for the beam report, or
an indication of a physical cell identification that the UE is to report within the beam report.

24. The base station of claim 17, wherein the one or more processors are further configured to:
transmit an indication of a configuration for receiving a set of periodic or semi-persistent reference signals for inter-cell multi-beam measurement.

25. The base station of claim 24, wherein the set of periodic or semi-persistent reference signals for inter-cell multi-beam measurement comprises one or more of:
one or more synchronization signal blocks (SSBs) having a same physical cell identification (PCI) as a serving cell PCI,
one or more SSBs having a different PCI from the serving cell PCI,
one or more channel state information (CSI) reference signals (RSs) associated with a first quasi-co-location (QCL) resource or a first root QCL resource that is a first SSB having the same PCI as the serving cell PCI, or
one or more CSI RSs associated with a second QCL resource or a second root QCL resource that is a second SSB having a different PCI from the serving cell PCI.

26. The base station of claim 17, wherein the event associated with beam reporting for inter-cell beam management comprises one or more of:
identification of one or more non-serving cells having a beam quality that is greater than a reference beam quality, or
identification of all reported cells as having beam qualities that are greater than the reference beam quality.

27. The base station of claim 26, wherein the beam qualities comprise one or more of:
an average beam quality of multiple beams having a same physical cell identification (PCI),
a minimum beam quality of the multiple beams having the same PCI,
a maximum beam quality of the multiple beams having the same PCI, or
sample beam qualities of multiple measurements of sets of beam qualities.

28. The base station of claim 26, wherein the event associated with beam reporting for inter-cell beam management comprises one or more of:
identification of one or more non-serving cells having a beam quality that is greater than the reference beam quality by a threshold amount, or
identification of all reported cells as having beam qualities that are greater than the reference beam quality by the threshold amount.

29. A method of wireless communication performed by a user equipment (UE), comprising:
detecting an event associated with beam reporting for inter-cell beam management; and
transmitting a beam report based at least in part on detecting the event.

30. A method of wireless communication performed by a base station, comprising:
transmitting, to a user equipment (UE), an indication of a configuration for transmitting a beam report based at least in part on detection of an event associated with beam reporting for inter-cell beam management; and
receiving the beam report based at least in part on detection of the event.
